(19) United States
(12) Patent Application Publication
(10) Pub. No.: US 2006/0027720 A1
(43) Pub. Date: Feb. 9, 2006

(54) Rolling sucker

(75) Inventors: Chen Yang Wu, Taipei (TW); Liang Ting Lee, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/195,675

(22) Filed: Aug. 3, 2005

(30) Foreign Application Priority Data
Aug. 6, 2004 (TW) 093123744

(51) Int. Cl. F16B 47/00; A45D 42/14

(52) U.S. Cl. 248/205.5

(57) ABSTRACT

A rolling sucker comprises a sucking disc, a pressing element and an adjusting rotation lid. In this case, a convex post is disposed extending from one surface of the sucking disc. The pressing element has a first surface facing the sucking disc, a second surface with a first connecting part and a first through hole going through the first surface and the second surface. The adjusting rotation lid has a second through hole. The convex post passes through the first and second through holes and has one part fixed on the adjusting rotation lid. One surface of the adjusting rotation lid facing to the pressing element has a second connecting part against the first connecting part. When rotating the adjusting rotation lid, the adjusting rotation lid pulls the convex post and the sucking disc so as to deform the sucking disc, which makes the sucking disc having an absorptive force.

### BACKGROUND OF THE INVENTION

1. Field of Invention

The invention relates to a sucker and, in particular, to a rolling sucker that is deformed to achieve the absorption effect by rotating the sucking disc.

2. Related Art

As shown in FIGS. 1 and 2, a conventional sucker 1 comprises a sucking disc 10, a rod clamp assembly 20, a shell 30 and an adjusting rotation lid 40.

The sucking disc 10 has a rise in the central surface and a convex post 11 is set on and protruding from the central surface. A circular groove 12 is provided on the surface of the convex post 11. The rod clamp assembly 20 comprises a spring 21, a suppression element 22 and a covering element 23. The covering element 23 has one end formed with a threaded rod 231 and the other end formed with a hollow tube 232. A slot 233 is configured on the surface of the tube 232. The shell 30 is a hollow tube, and two opposed rails 31 are set on the inner wall of the shell 30. The inner surface of the adjusting rotation lid 40 is provided with threads 41.

The configurations among the aforementioned elements are described as follows. The spring 21 of the rod clamp assembly 20 and the suppression element 22 are assembled in the tube 232. The tube 232 covers the convex post 11 of the sucking disc 10, and a retainer 234 is retained in the slot 233 and circular groove 12, so as to combine the rod clamp assembly 20 and the sucking disc 10. The shell 30 covers the rod clamp assembly 20 and the sucking disc 10, and the threaded rod 231 at one end of the rob clamp assembly 20 protrudes from the shell 30. To fix the covering element 23, the two sides of the covering element 23 of the rod clamp assembly 20 are assembled in the opposite rails 31 in the inner wall of the shell 30. The adjusting rotation lid 40 is connected with the threaded rod 231 of the rod clamp assembly 20 via the threads 41. By moving the adjusting rotation lid 40, one side of the adjusting rotation lid 40 can press against the shell 30.

When the user rotates the adjusting rotation lid 40, the adjusting rotation lid 40 is adjusted to suppress the shell 30 and rod clamp assembly 20. Accordingly, the sucking disc 10 is suppressed, and is thus deformed for attaching to the wall.

The structure of the conventional sucker, however, is very complicated, which results in a complex assembling process and a high production cost.

It is therefore an important subjective to provide a sucker that is safe and easy to use, and has simple components.

### SUMMARY OF THE INVENTION

In view of the foregoing, the present invention is to provide a rolling sucker that is safe and easy to use, and has simple components.

To achieve the above, a rolling sucker of the invention comprises a sucking disc, a pressing element and an adjusting rotation lid. In this case, a convex post is set extending from one surface of the sucking disc. The pressing element has a first surface, a second surface and a first through hole. The first through hole passes through the first surface and the second surface. The first surface faces to the sucking disc and the second surface has at least one first connecting part. The adjusting rotation lid has a second through hole. The convex post passes through the first through hole and the second through hole in sequence. One part of the convex post is fixed on the adjusting rotation lid. At least one second connecting part is set on one surface of the adjusting rotation lid facing to the pressing element. The second connecting part is against the first connecting part. When the adjusting rotation lid is rotated, the second connecting part is sliding along the first connecting part, resulting in that the adjusting rotation lid is away from the pressing element and at least one part of the pressing element presses the sucking disc. In the meantime, the adjusting rotation lid pulls the convex post and the sucking disc so as to deform the sucking disc and then make the sucking disc having an absorptive force.

As mentioned above, by rotating the adjusting rotation lid of the rolling sucker of the invention, the distance between the pressing element and the adjusting rotation lid is increased. Thus, the convex post, which passes through the adjusting rotation lid and the pressing element and is partially fixed to the adjusting rotation lid, can cause the deformation of the sucking disc so as to create an absorptive force. Therefore, the user can stick the rolling sucker to a specific surface by simply rolling the adjusting rotation lid. In addition, for sucker manufacturers, since the structure of the rolling sucker is simple, the production cost and the labor cost can be reduced.

### BRIEF DESCRIPTION OF THE DRAWINGS

The invention will become more fully understood from the detailed description given herein below illustration only, and thus is not limitative of the present invention, and wherein:

FIG. 1 is an explosive diagram showing the structure of the conventional sucker;

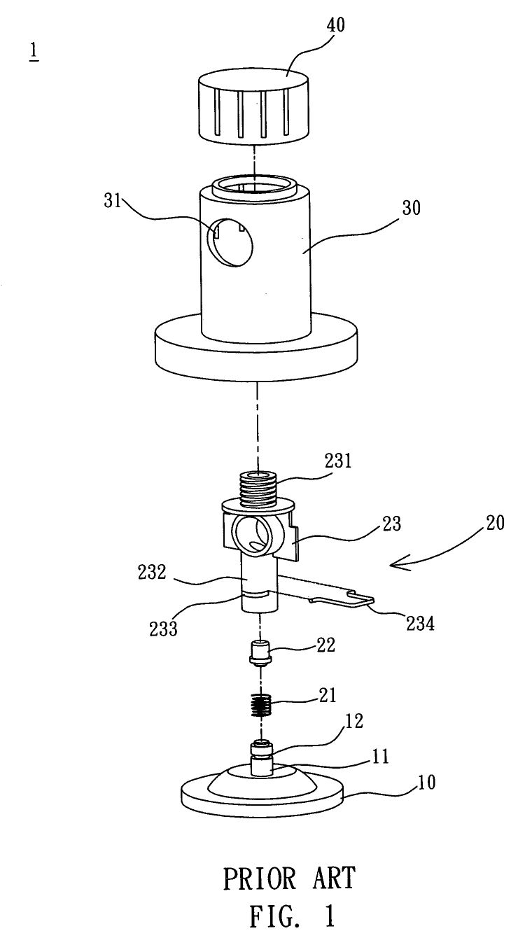

FIG. 2 is a cross-sectional diagram showing the structure of the conventional sucker;

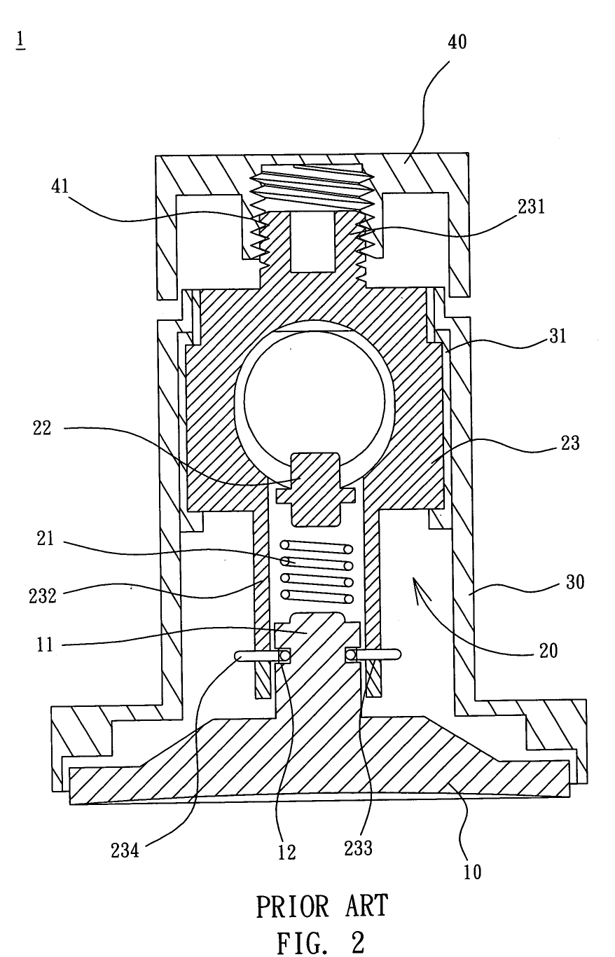

FIG. 3 is an explosive diagram showing a rolling sucker according to a preferred embodiment of the invention;

FIG. 4 is an explosive diagram showing the bottom view of the rolling sucker according to the preferred embodiment of the invention;

FIG. 5 is a diagram showing the rolling sucker according to a preferred embodiment of the invention;

FIG. 6 is a diagram showing another rolling sucker according to the preferred embodiment of the invention;

FIG. 7 is a partial enlarged diagram showing the cross-sectional view of the rolling sucker according to the preferred embodiment of the invention;

FIG. 8 is a cross-sectional diagram showing the operation of the rolling sucker according to the preferred embodiment of the invention;

FIG. 9 is a diagram showing the operation of the rolling sucker according to the preferred embodiment of the invention; and

FIG. 10 is a diagram showing the rolling sucker in use according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

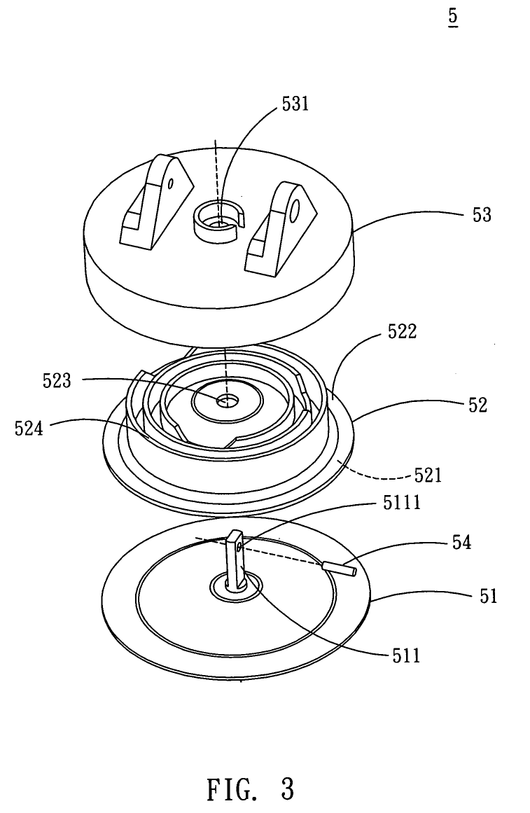

With reference to FIG. 3, a rolling sucker 5 according to the preferred embodiment of the invention comprises a sucking disc 51, a pressing element 52 and an adjusting rotation lid 53.

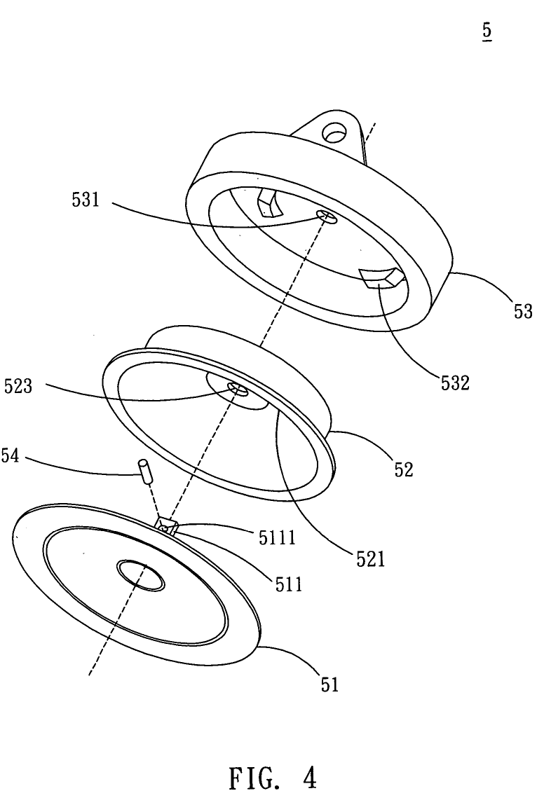

A convex post 511 is set extending from one surface of the sucking disc 51. The pressing element 52 has a first surface 521, a second surface 522 and a first through hole 523. The first through hole 523 passes through the first surface 521 and the second surface 522. The second surface 522 has at least one first connecting part 524. The adjusting rotation lid 53 has a second through hole 531. At least one second connecting part 532 is set on one surface of the adjusting rotation lid 53 facing to the pressing element 52 (as shown in FIG. 4).

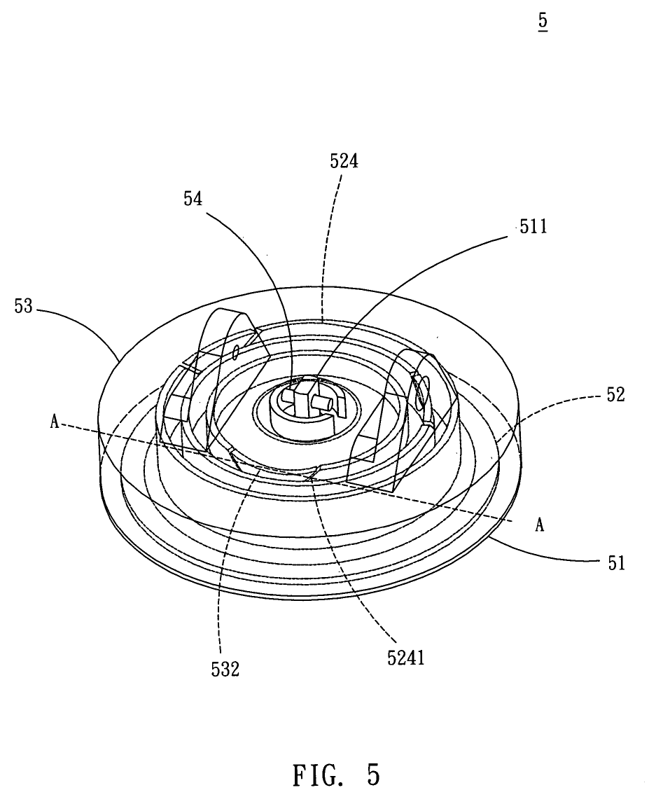

The first surface 521 of the pressing element 52 faces to the sucking disc 51. The convex post 511 of the sucking disc 51 passes through the first through hole 523 of the pressing element 52 and the second through hole 531 of the adjusting rolling lid 53 in sequence. The convex post 511 comprises a fasten hole 5111, and the components of the rolling sucker 5 is fixed by a bolt 54, which passes through the fasten hole 5111 so as to fix a part of the convex post 511 to the adjusting rotation lid 53. Accordingly, the adjusting rotation lid 53 covers the pressing element 52 and connects to the sucking disc 51 (as shown in FIG. 5). As previously mentioned, the sucking disc is made of a soft material, suck as thermoplastic elastomer or polyvinyl chloride.

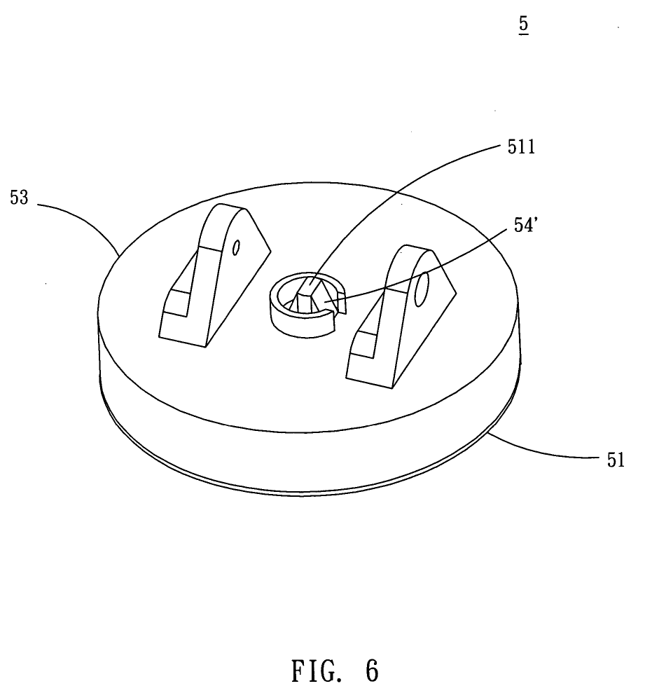

Further, as shown in FIG. 6, the convex post 511 can be fastened on the adjusting rotation lid 53 with an additional structure so as to connect the adjusting rotation lid 53 to the sucking disc 51. In this case, the additional structure is a restraining element 54′ that set at one end of the convex post 511. The restraining element 54 is contractive, and therefore the convex post 511 can pass through the first through hole 523 and the second through hole 531 and fasten to the adjusting rotation lid 53.

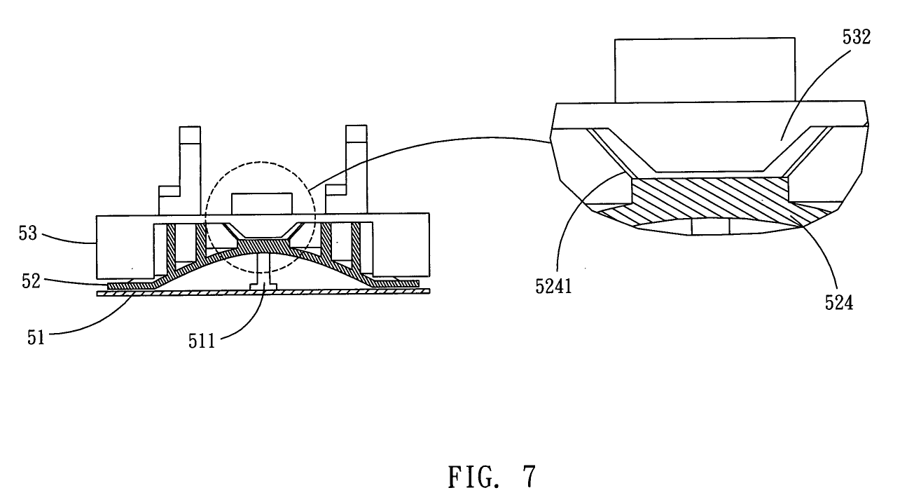

In this embodiment, as shown in FIG. 7 that is a partial enlarged diagram showing a cross-sectional view taken along the dash line A-A in FIG. 5, the second connecting part 532 of the adjusting rotation lid 53 is against the first connecting part 524 of the pressing element 52. The first connecting part 524 is at least a rail with a non-planar route. The second connecting part 532 is a protrusion, and the adjusting rotation lid 53 is against the rail via the protrusion. In this case, the shape of the rail may be a protruding stripe which further comprising a notch 5241, wherein the notch 5241 has at least one inclined plane. As shown in FIG. 7, the notch 5241 is in a wedge shape.

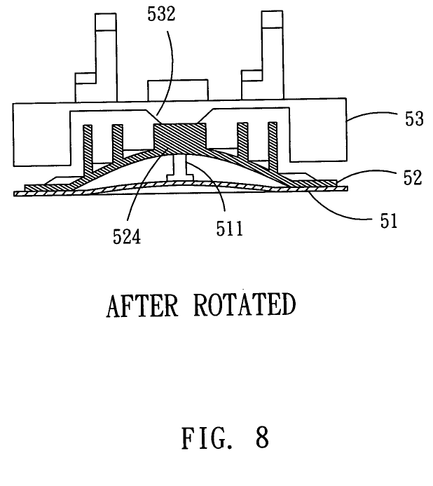

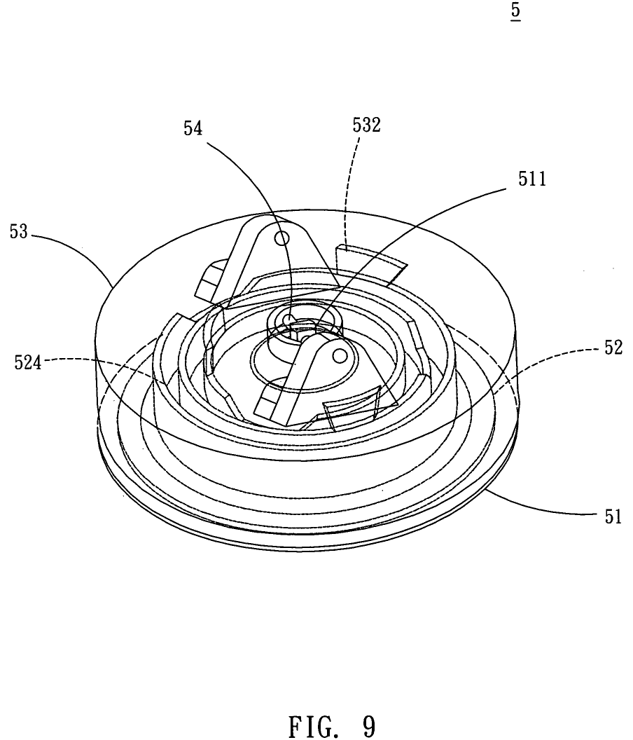

As shown in FIGS. 8 and 9, when the adjusting rotation lid 53 is rotated, the second connecting part 532 of the adjusting rotation lid 53 slides along the first connecting part 524 of the pressing element 52. In the meantime, at least one part of the pressing element 52 presses the sucking disc 51, and the adjusting rotation lid 53 pulls the convex post 511 and the sucking disc 51 so as to deform the sucking disc and create an absorptive force. In this case, the pressing element 52 is in a cap-like shape, and when at least one part of the pressing element 52 presses the sucking disc 51, the adjusting rotation lid 53 pulls the convex post 511 to deform the sucking disc 51. This may compress the space between the pressing element 52 and the sucking disc 51. An absorptive force of the rolling sucker 5 is therefore created.

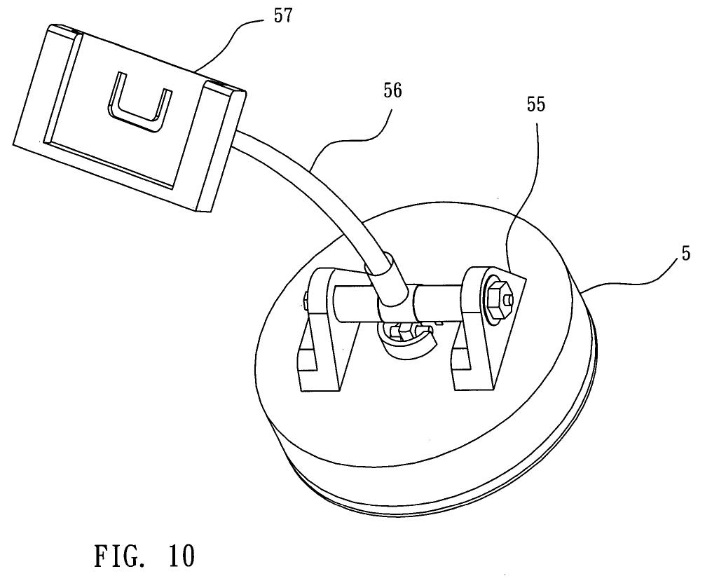

In addition, as shown in FIG. 10, the rolling sucker 5 according to the preferred embodiment of the present invention further comprises at least one connecting unit 55, which is set on another surface of the adjusting rotation lid 53. The connecting unit 55 connects to one end of a stick portion 56, while the other end of the stick portion 56 connects to a carrying base 57 for carrying an electrical apparatus. In the present embodiment, the rolling sucker 5 can be used on a car, and for example, be attached to the glass of a car for further carrying an electrical apparatus.

To make the invention more comprehensive, the flows of using the rolling sucker according the preferred embodiment of the invention will be described hereinafter.

Herein, the sucking disc 51 of the rolling sucker 5 is placed on the surface to be attached the glass, for example, of a car. Since the protrusion of the adjusting rotation lid 53 is against the notch 5241 on the rail of the pressing element 52 (as shown in FIG. 5), and the protrusion has at least one inclined plane, the protrusion is sliding along the rail when the adjusting rotation lid 53 is rotated. Thus, the distance between the adjusting rotation lid 53 and the pressing element 52 can be increased. Because the sucking disc 51 is made of a soft material, the protrusion 511 can be pulled to a specific position with the adjusting rotation lid 53. Accordingly, the sucking disc 51 is deformed and an absorptive force is thus created (as shown in FIG. 9).

In summary, the mechanism of the rolling sucker according to the present invention is that when the adjusting rotation lid is rotated, it pulls the protrusion of the sucking disc for deforming the sucking disc that made of a soft material to create an absorptive force. The rolling sucker assembled by the aforementioned components can achieve the same effect as the conventional sucker, and has a much simpler structure than the conventional sucker. Therefore, the assembling process can be simplified and the production cost is thus reduced. Moreover, the rolling sucker is convenient and safe to use since the absorption effect can be achieved by a simple rolling step.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A rolling sucker, comprising:
a sucking disc having a surface and a convex post set protruding from the surface;
a pressing element having a first surface, a second surface and a first through hole, wherein the first through hole passes through the first surface and the second surface, the first surface faces to the sucking disc, and the second surface comprises at least one first connecting part; and
an adjusting rotation lid having a second through hole, wherein the convex post passes through the first through hole and the second through hole in sequence, one part of the convex post is fixed on the adjusting rotation lid, at least one second connecting part is set on one surface of the adjusting rotation lid facing to the pressing element, the second connecting part is against the first connecting part, and when the adjusting rotation lid is rotated, the second connecting part is sliding along the first connecting part, resulting in that the adjusting rotation lid is away from the pressing element, and at least one part of the pressing element presses the sucking disc such that the adjusting rotation lid pulls the convex post and the sucking disc to deform the sucking disc and then make the sucking disc having an absorptive force.

2. The rolling sucker according to claim 1, wherein the first connecting part is at least a rail, the second connecting part is a protrusion, the protrusion is against the rail, and the rail has a non-planar route.

3. The rolling sucker according to claim 2, wherein the protrusion has at least one inclined plane.

4. The rolling sucker according to claim 2, wherein the rail is a protruding stripe having at least one notch.

5. The rolling sucker according to claim 4, wherein at least one side of the notch is an inclined plane.

6. The rolling sucker according to claim 4, wherein the notch is in a wedge shape.

7. The rolling sucker according to claim 1, wherein the convex post comprises a fasten hole, and a bolt passes through the fasten hole so as to connect the adjusting rotation lid to the sucking disc.

8. The rolling sucker according to claim 1, wherein the convex post comprises a restraining element, and the restraining element is set on one end of the convex post for connecting the adjusting rotation lid to the sucking disc.

9. The rolling sucker according to claim 1, wherein the pressing element is in a cap-like shape.

10. The rolling sucker according to claim 1, wherein when the adjusting rotation lid is rotated, at least one part of the pressing element approaches the sucking disc, and the deformed sucking disc causes a compression space between the pressing element and the sucking disc.

11. The rolling sucker according to claim 1, wherein at least one connecting unit is set on another surface of the adjusting rotation lid, the connecting unit connects to one end of a stick portion, and another end of the stick portion connects to a carrying base.

12. The rolling sucker according to claim 11, wherein the carrying base carries an electrical apparatus.

13. The rolling sucker according to claim 1, wherein the sucking disc is made of a soft material.

14. The rolling sucker according to claim 1, wherein the sucking disc is made of a thermoplastic elastomer.

15. The rolling sucker according to claim 1, wherein the sucking disc is made of polyvinyl chloride.
